(19) United States
(12) Patent Application Publication
(10) Pub. No.: US 2015/0273726 A1
(43) Pub. Date: Oct. 1, 2015

(54) Temporary Road Mat Assembly Apparatus and Method

(71) Applicants: Walter Marsh, Richmond, VA (US); Patrick Evelyn, New Kent, VA (US)

(72) Inventors: Walter Marsh, Richmond, VA (US); Patrick Evelyn, New Kent, VA (US)

(73) Assignee: Charles City Timber and Mat, Inc., Providence Forge, VA (US)

(21) Appl. No.: 14/514,755

(22) Filed: Oct. 15, 2014

Related U.S. Application Data
(60) Provisional application No. 61/891,161, filed on Oct. 15, 2013.

(51) Int. Cl. B27M 3/00; B27C 3/04; B27C 9/04; E01C 9/08

(52) U.S. Cl. CPC B27M 3/0013; E01C 9/086; B27C 3/04; B27C 9/04

(57) ABSTRACT

An apparatus for producing timber mats including plural layers of timbers that are parallel to each other and offset from each another at uniform intervals, wherein timbers in adjacent layers are oriented perpendicular to one another forming an array of intersections spaced in longitudinal columns and lateral rows, the apparatus comprising a timber mat layup table; a first lateral timber input oriented in a first direction and arranged at a first side of the timber mat layup table; a second lateral timber input oriented in a second direction opposite, coaxial and parallel to the first direction and arranged at a second side of the timber mat layup table opposite to the first side of the timber mat layup table; a longitudinal timber input oriented in a third direction perpendicular to the first direction and the second direction and arranged at a third side of the timber mat layup table.

### RELATED APPLICATIONS

This application claims priority from U.S. Provisional Patent Application 61/891,161 filed on Oct. 15, 2013 which is incorporated in its entirety by this reference.

### FIELD OF THE INVENTION

The present invention relates to an apparatus and a method for assembling two and three ply temporary road mats.

### BACKGROUND OF THE INVENTION

Temporary road mats are used extensively to allow vehicles and equipment to reach locations not serviced by permanent roads, particularly under conditions where a ground surface would not support the traffic or where the temporary nature of use does not warrant the time and expense of a permanent road. The temporary road mats are generally constructed from multiple layers of heavy wood timbers in crisscrossing layers.

The timber mats are typically laid up by hand on a conveyor, drilled by hand, the timbers are cut to length by hand and the bolts inserted by hand which is very labor intensive and not very precise.

Timber mat production machines are known devices and disclosed in U.S. Pat. No. 6,745,452, U.S. Pat. No. 7,210,211; U.S. Pat. No. 8,066,447 and provide mechanization and automation to part of the production process. The present invention improves upon the known devices.

### BRIEF SUMMARY OF THE INVENTION

It is the object of the invention to provide an apparatus for industrialized high volume production of timber mats which offers a higher level of precision and cost savings over manual production.

The object is achieved by an apparatus for producing timber mats including plural layers of timbers that are parallel to each other and offset from each another at uniform intervals in each layer, wherein timbers in adjacent layers are oriented perpendicular to one another forming an array of intersections spaced in longitudinal columns and lateral rows, the apparatus including a timber mat layup table; a first lateral timber input oriented in a first direction and arranged at a first side of the timber mat layup table; a second lateral timber input oriented in a second direction opposite, coaxial and parallel to the first direction and arranged at a second side of the timber mat layup table opposite to the first side of the timber mat layup table; a longitudinal timber input oriented in a third direction perpendicular to the first direction and the second direction and arranged at a third side of the timber mat layup table; a timber mat output oriented in the third direction arranged at a fourth side of the timber mat layup table opposite to the third side of the timber mat layup table; a timber mat drilling table arranged adjacent to the timber mat output on a side of the timber mat output that is opposite to the timber mat layup table; a gang drill arrangement that is movable in the first direction and in the second direction and includes plural drilling heads spaced in the third direction to drill the timber mat including plural layers of mutually perpendicular timbers in a vertical direction at the intersections of the timbers.

The object is also achieved by a method for producing timber mats including the steps: feeding timbers in at least one lateral direction to a timber mat layup table through at least one lateral timber input; feeding timbers in a longitudinal direction perpendicular to the at least one lateral direction to the timber mat layup table through a longitudinal timber input; laying up timbers in at least two layers with the timbers of each layer arranged perpendicular to one another to form a timber mat; moving the timber mat from the timber mat layup table through a timber mat output coaxial and parallel to the longitudinal timber a side of the timber mat layup table that is opposite to the longitudinal timber input to a drilling table arranged adjacent at the mat output opposite to the mat layup table; drilling the timber mat through a gang drill a arrangement at the drilling table which gang drill arrangement is movable back and forth in the lateral direction and includes plural drilling heads spaced in the longitudinal direction to drill the timber mat at intersection points of the timbers.

### BRIEF DESCRIPTION OF THE DRAWINGS

The invention is described based on advantageous embodiments with reference to drawing figures, wherein:

FIG. 1 illustrates a perspective top view of the timber mat production apparatus according to the invention;

FIG. 2 illustrates a column de-stacker according to the invention;

FIG. 3 illustrates a timber centering device according to the invention and a circular saw feed device according to the invention;

FIG. 4 illustrates a timber separator according to the invention;

FIG. 5 illustrates a pick and place robot according to the invention;

FIG. 6 illustrates a drilling table with a gang drill arrangement according to the invention;

FIG. 7 illustrates a drill frame with drive device according to the invention;

FIG. 8 illustrates a drill frame slide device according to the invention;

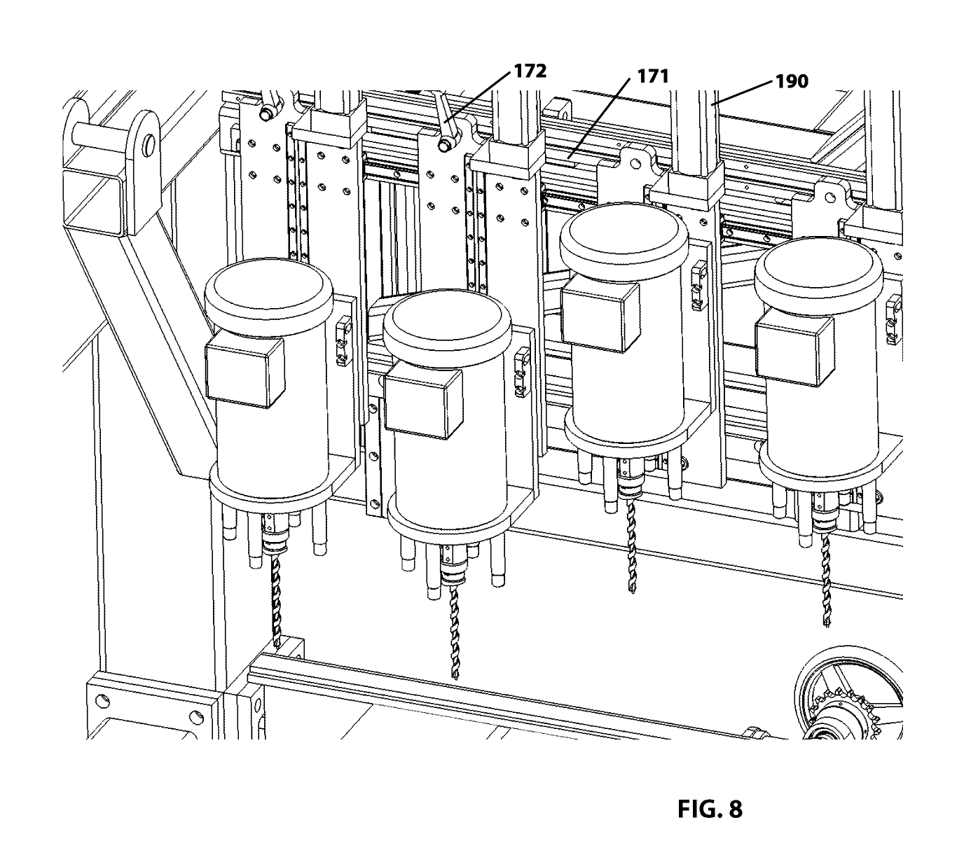

FIG. 9 illustrates a drill head with a vertical slide according to the invention, and

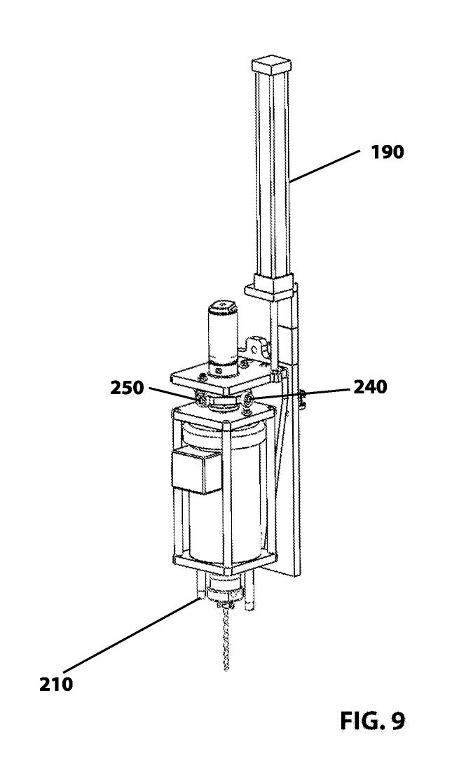

FIG. 10 illustrates a known timber mat; and

FIG. 11 illustrates an exploded view of the known timber mat according to FIG. 10.

### DETAILED DESCRIPTION OF THE INVENTION

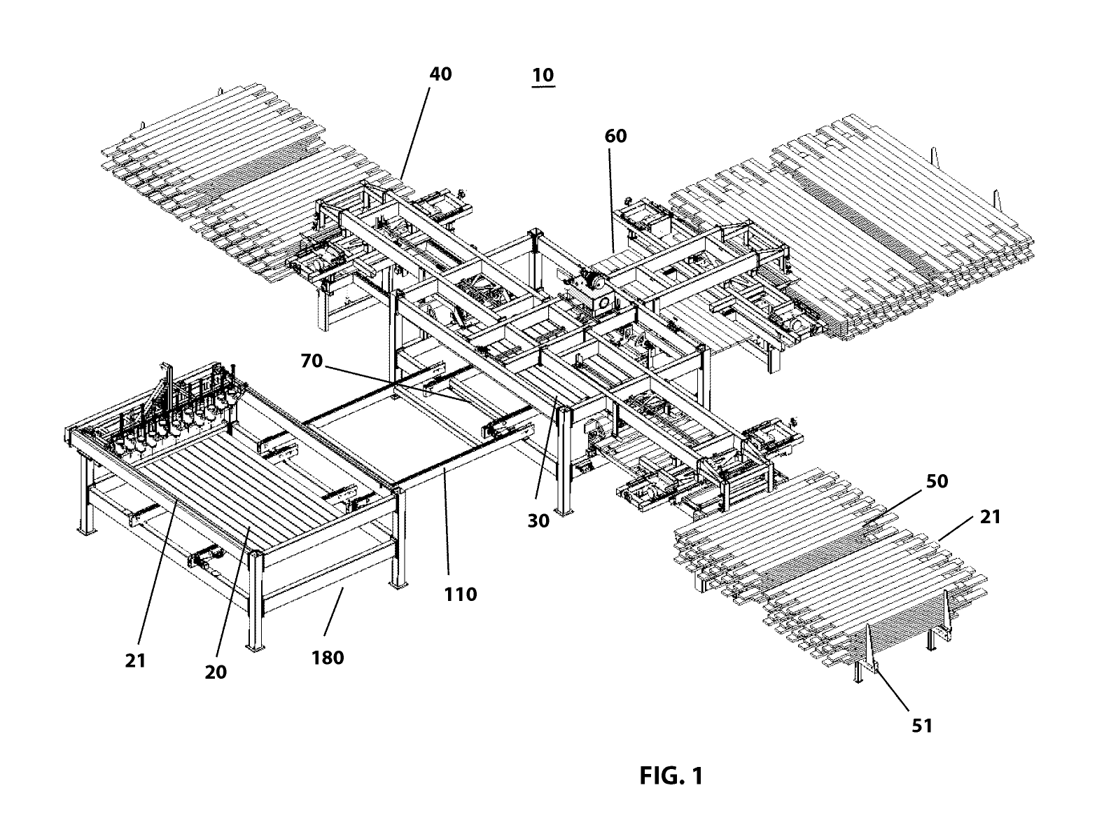

FIG. 1 illustrates an assembly apparatus 10 for timber mats 20. The assembly apparatus 10 includes a timber mat layup table 30 with a first lateral timber input 40, a second lateral timber input 50 and a longitudinal timber input 60.

The timber mats 20 include two or three layers of timbers 21. The timbers are parallel to each another and laterally offset from one another at uniform intervals in each layer. Timbers in adjacent layers are oriented perpendicular to each other. The timbers are typically made from oak and typically 2 inches thick, 8 inches wide and 8-20 feet long. The timber mats typically have a size of 8 feet×14 feet.

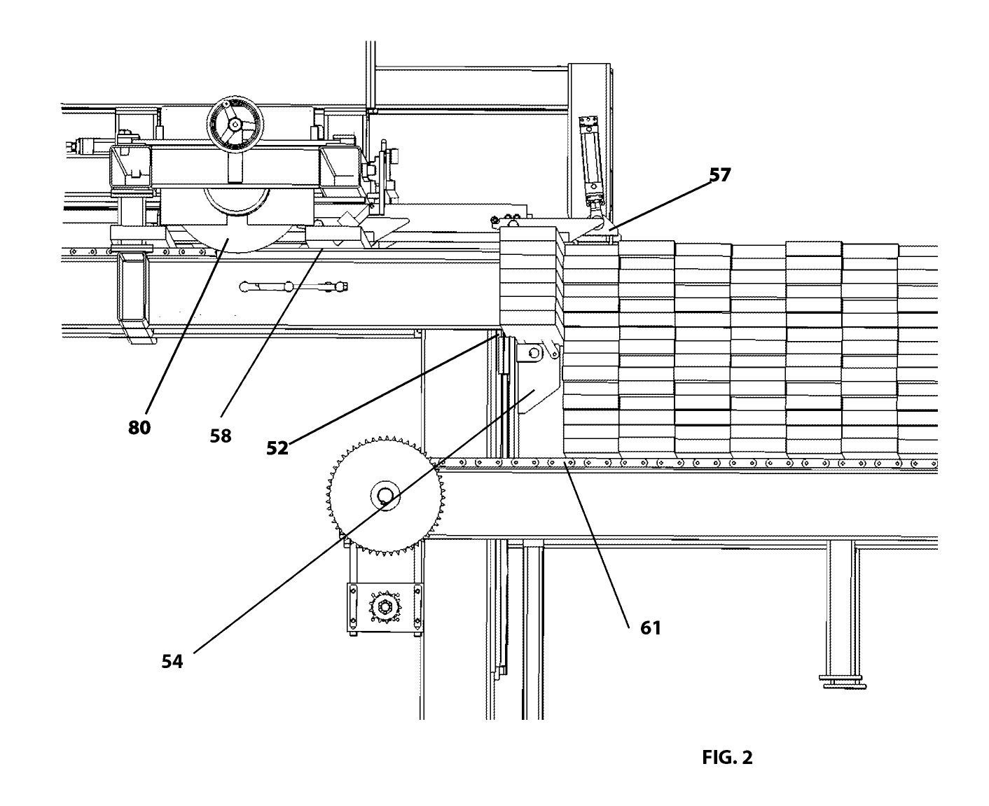

The three timber mat inputs 40, 50 and 60 function analogously. Therefore only the function of the second lateral timber input 50 is described in detail in an exemplary manner. A forklift places timbers strapped into bundles approximately 3 ft tall and 4 ft wide on an infeed conveyor 51 illustrated in FIG. 2. Then the metal retaining straps of the bundles are cut.

The infeed conveyor chain 61 is moved forward and a first bundle of timbers 21 is pulled against a squaring angle 52 at an end of the in-feed conveyor 51 that is proximal to a column de-stacker 55. The bundle which has a maximum height of 29″ is squared and aligned at a squaring angle 52 through moving it against the squaring angle with an in feed conveyor chain 61 running towards the squaring angle.

Then the in feed conveyor 51 is stopped and the first column of the bundle is held at the squaring angle by a pair of grippers 54 of which only one is shown in FIG. 2. The pair of grippers 54 is raised slightly so that the first column of timbers is lifted off the conveyor chain and the remaining columns are then moved back by approximately 1″ by running the conveyor chain backwards so that the first column is separated from the other columns and accessible to the column de-stacker 55.

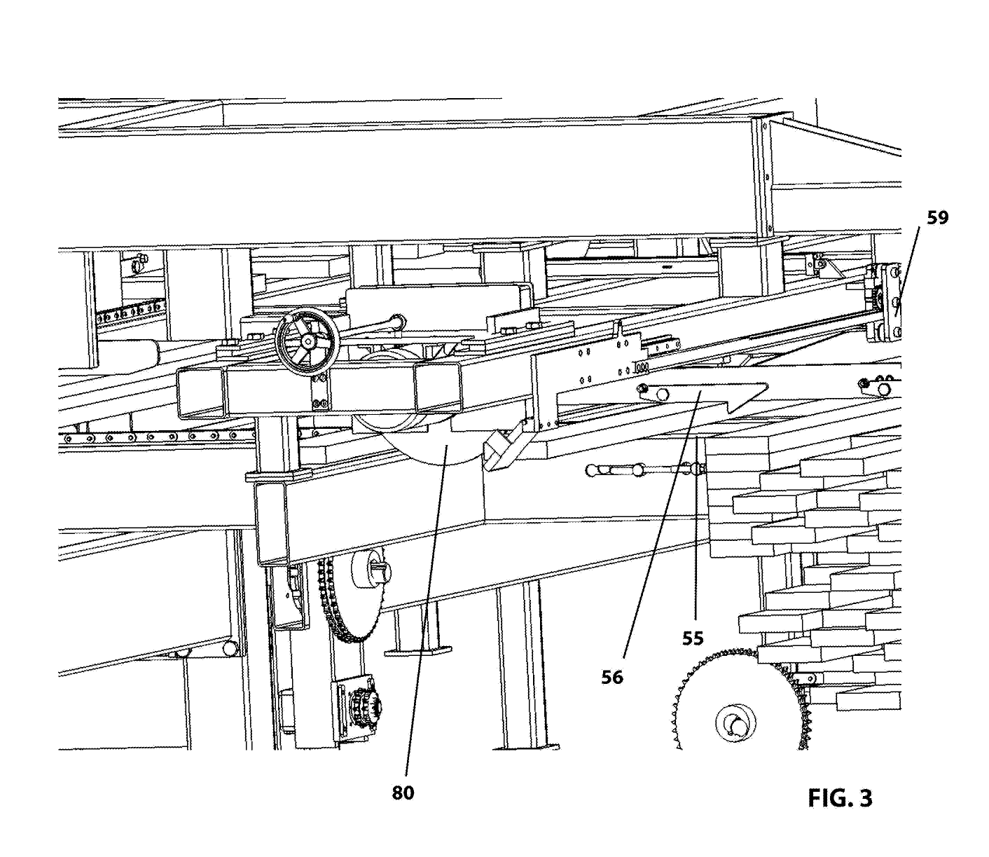

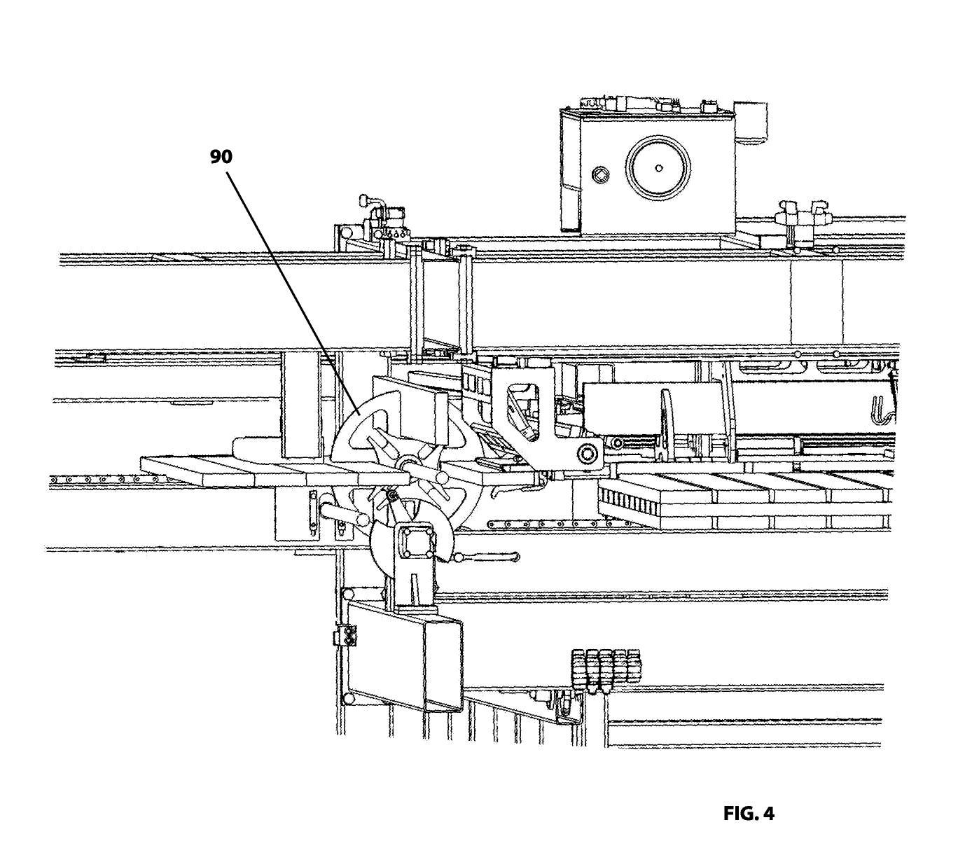

The first column of timbers is raised by the pair of grippers 54 until the top timber hits until a vertical limit 57. When the top timber is at a defined height the de-stacker 55 with a finger hook 56 engages the top timber of first the column and pulls the top timber onto a slide 58 rail towards a centering device 59 as illustrated in FIGS. 3 and 4. The centering device 59 includes two centering arms connected by a gear mechanism that center the timber along its longitudinal extension relative to a circular saw arrangement 80 that includes two circular saws. This assures that the timbers are cut to a predetermined length and an even amount of length is cut off from the timbers at both ends.

After the centering device 59 the timber is pulled by two saw feed hooks 63 onto the sawing table and pulled through the circular saw arrangement 80 including two circular saw blades.

The first column of timbers is then moved up by one timber so that it contacts the limit switch 57 again so that another timber can be fed to the circular saw arrangement.

After the circular saw the timbers continue on a separator feed chain conveyor 64 into a separator 90 typically configured as a Geneva device that picks up one timber at time and flips it over laterally by 180° to separate timbers on the separator feed conveyor coming from the circular saw arrangement as illustrated in FIG. 4.

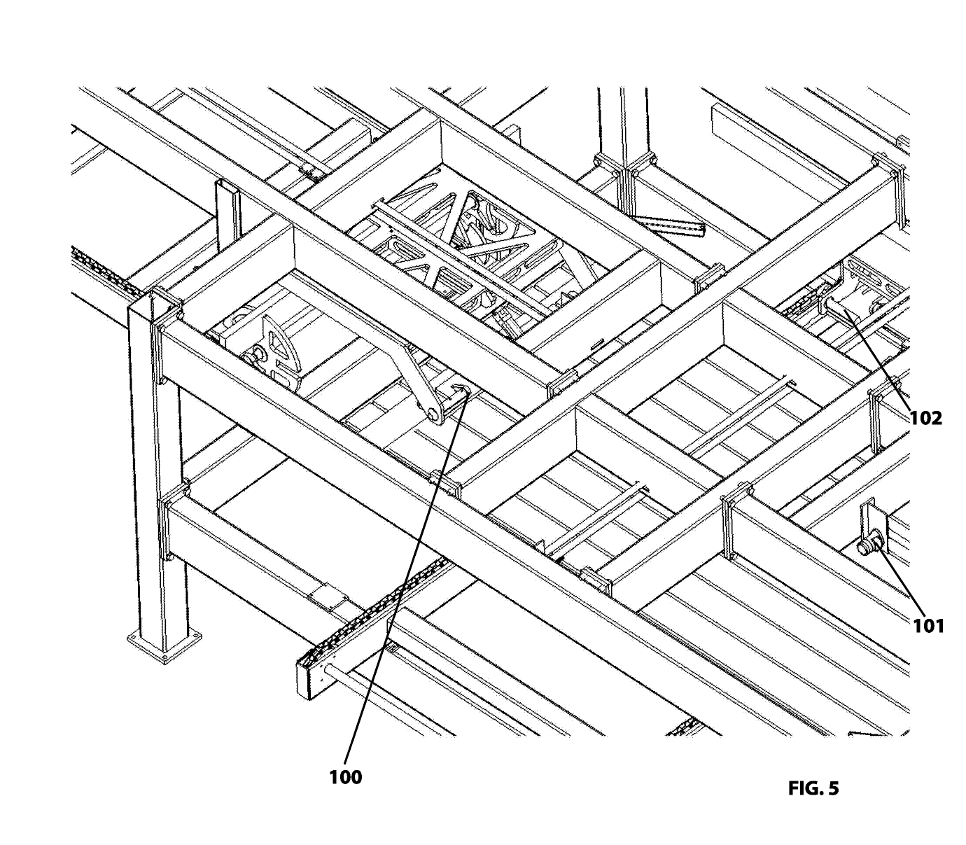

A pick and place arm 100 with a clamping device which laterally clamps the timbers picks up a timber from the Geneva device 90, tilts it slightly so that its rear end in movement direction drags over the layup table 30 or over timbers already placed on the layup table and moves the timber to a defined position on the timber mat layup table 30 and drops it in place as illustrated in FIG. 5.

The pick and place arm 100 can is movable to offset the timbers longitudinally by a predetermined amount along their extensions for mat keying. Mat keying helps to connect timber mats with one another.

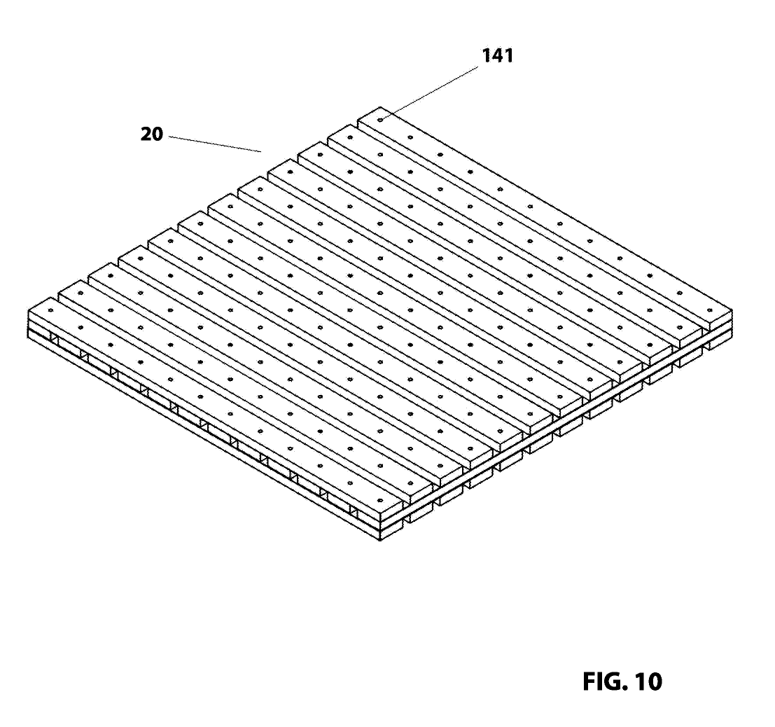

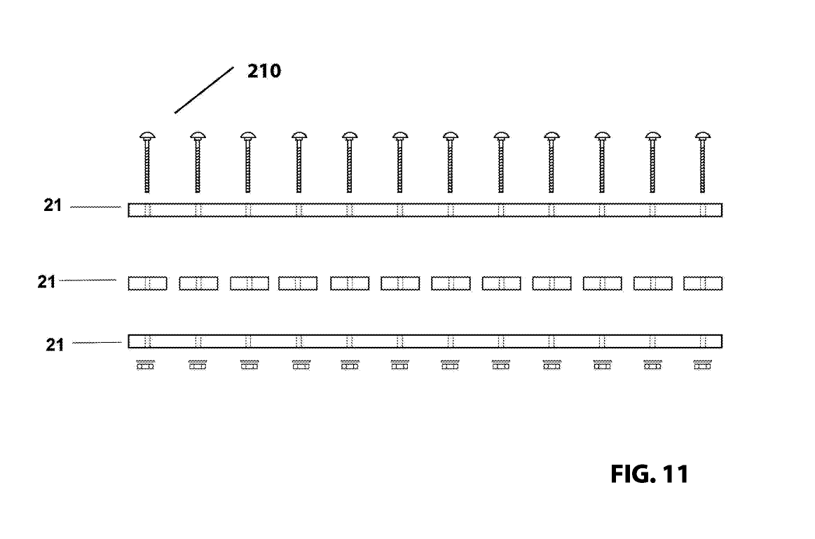

The laid up timber mat 140 that has two or three layers of timbers that are parallel and spaced in uniform intervals in each layer. An orientation of timbers in one layer is perpendicular to an orientation of timbers in an adjacent layer as illustrated in FIGS. 10 and 11.

A first layer of timbers is fed from the first lateral timber input 40 or the second lateral timber input 50, a second layer of timbers is fed from the longitudinal timber input 60 and an optional third layer of timbers may be fed from the first lateral timber input 40 or the or the second lateral timber input 50. Typically the first layer of timbers will be fed by one lateral timber input and the third layer of timbers will be fed by another lateral timber input as illustrated in FIG. 1.

After completion the timber mat is pulled off the timber mat layup table 30 at a timber mat output 70 and moved onto a timber mat drilling table 180 by a connecting chain conveyor 110.

An end position switch for the chain conveyor 110 on the timber mat drilling table 180 assures that the timber mat is positioned correctly.

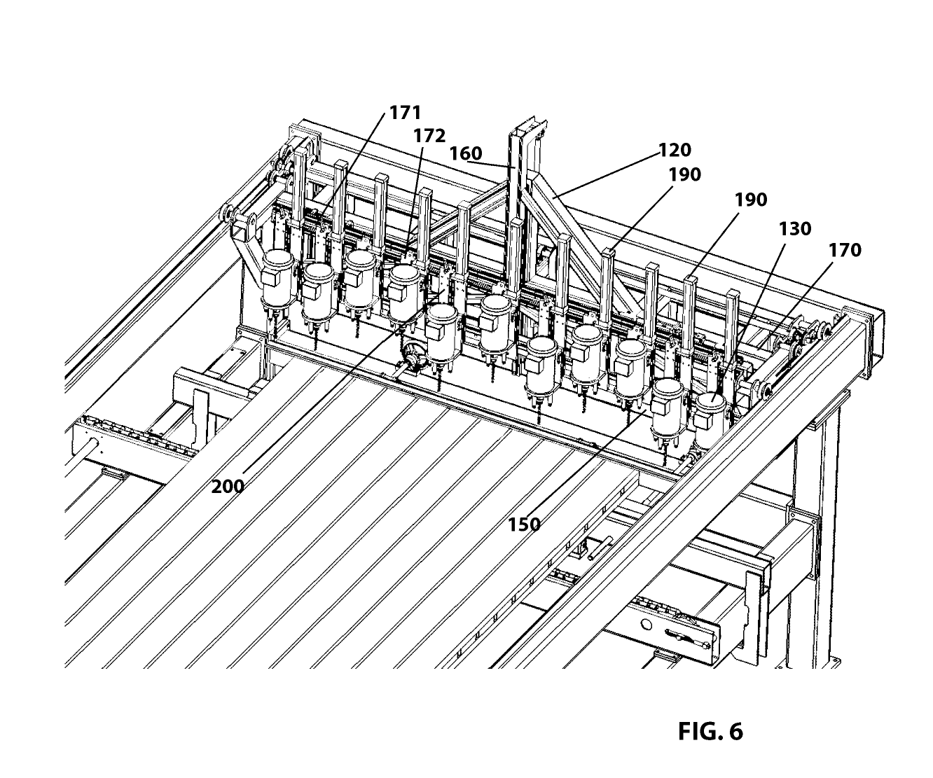

As illustrated in FIG. 6 a gang drill arrangement 120 typically with eleven drill heads 130 uniformly spaced in the feed direction is attached to a drill head carrier 150 that travels transversal to the feed direction of the timber mat onto the drilling table in the first direction and in the second direction along the timber mat to drill all intersections of the timber mat vertically with bore holes 141 to receive connection bolt assemblies 210 as illustrated in FIGS. 11 and 12. The drill head carrier 150 is moved transversal to the feed direction of timber mat 20 by a drill head carrier drive 220. The timber mat 20 is typically eleven timbers wide in the feed direction.

For drilling operations the drill head carrier 150 is moved up and down by a hydraulic cylinder on a vertical drill head carrier slide 160. The vertical stroke of the drill head carrier is typically 8 inches to drill through a timber mat which is typically 6 inches thick and to countersink the borehole for a washer and a nut.

The entire arrangement of eleven drill heads is driven back and forth in the feed direction of the timber mat on a horizontal drill head carrier slide 170 between a forward position, a center position, and a rear position in order to laterally offset all drill holes of one row relative to intersection centers of the timbers. The back and forth movement of the arrangement of the eleven drill head is controlled by a drill head offset drive 230.

Additionally each drill head is individually adjustable on a manual drill head adjustment slide 171 by hand by opening and closing a clamping device 172 when the drill head carrier is standing still.

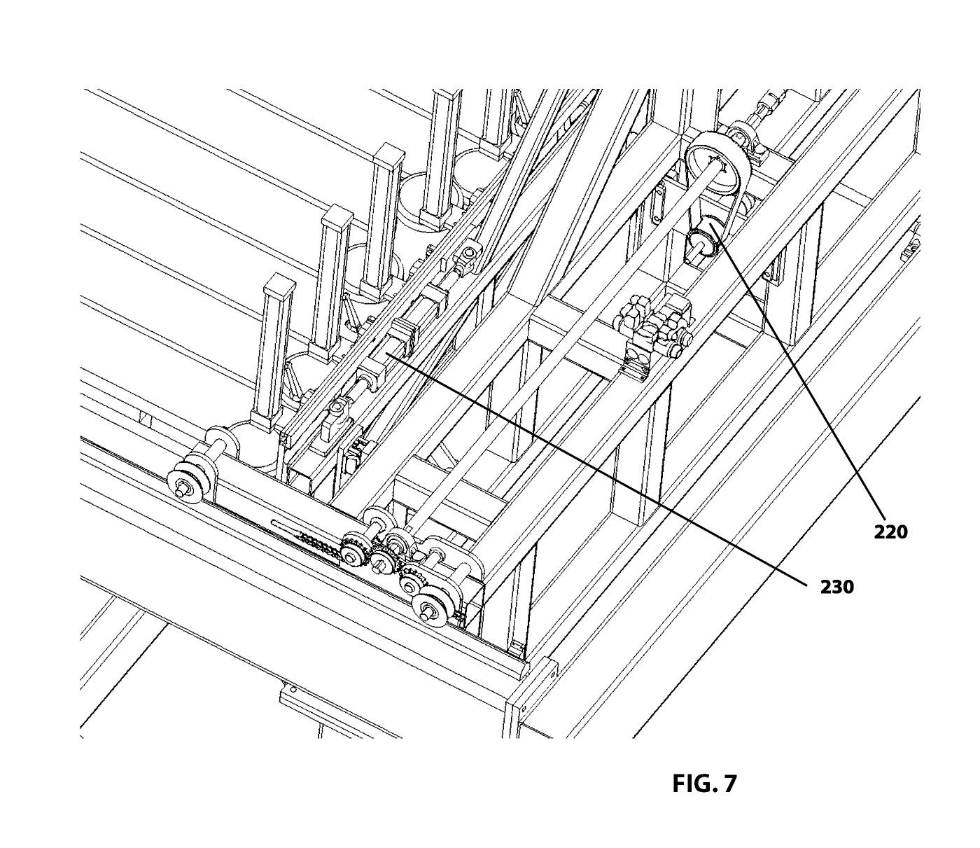

As illustrated in FIG. 7 each drill head moves up and down on an individual vertical drill head slide 200 and is loaded by an individual air cylinder 190. To start the drilling process the drill head carrier 150 is moved down so that each drill contacts a top surface of a timber. Then pressure is supplied to each individual air cylinder 190 and the drill heads move down on their individual drill head slides.

Each drill head has at least one individual spacer 220 that contacts a timber top surface when the drill head has reached its final depth including the countersinking. The individual air cylinders 190 provide uniform drilling pressure and drill depth for all drill heads irrespective of surface unevenness of the timber mat since each drill head can move independently from the other drill heads and will only come to a stop when its spacer 220 contacts the timber top surface.

The drill diameter is typically ⅜41 and the drill depth is typically 6.5″ to drill up to three timbers each 2″ thick. The drills have counter sinkers at their ends to drill the top timber so a washer and a nut can be recessed therein.

A hydraulic motor moves the drill head frame 190 transversal to the feed direction of the timber mat from one row of intersections to another and down the columns of intersections. A hydraulic cylinder moves the drill head carrier up and down on the vertical drill head slide for drilling insertion holes for the mounting bolts of the mounting bolt assembly 210.

In an advantageous embodiment the drill heads are pivotable about two axes about universal two universal joints 240 and two universal joints 250. The drill heads are gravity positioned about both axes defined by the universal joints 240 and 250. Once the drills have started drilling into the timber mat they can pivot about both axes to correct for uneven fiber distributions in the timbers which tend to fracture drill bits when no pivotability is provided.

The control system features Windows 8 touch screen operations and 1/1000 rev encoders. Eight axes of movement are being controlled. The timber mat production machine includes six ethernet PLCs and twenty I/Os.

### REFERENCE NUMERALS AND DESIGNATIONS

10 timber mat assembly apparatus
20 timber mat
21 timber
30 layup table
40 first lateral timber input
50 second lateral timber input
51 in feed conveyor
52 squaring angle
54 gripper
55 de-stacker
56 finger hook
57 vertical limit
58 slide rail
59 centering device
60 longitudinal timber input
61 infeed conveyor chain 61
62 saw extraction conveyor
63 saw feed hook
64 separator feed conveyor
65 alignment arm
70 timber mat output
80 circular saw arrangement
90 separator
100 pick and place arm
101 pick and place arm
102 pick and place arm
110 connecting chain conveyor
120 gang drill arrangement
130 drill head
140 timber mat
141 bore hole
150 drill head carrier
160 vertical drill head carrier slide
170 horizontal drill head carrier slide
171 manual drill head adjustment slide
172 clamping device
180 timber mat drilling table
190 individual drill head air cylinder
200 individual vertical drill head slide
210 connection bolt assembly
220 drill head carrier drive
230 drill head offset drive
240 universal joint
250 universal joint

What is claimed is:

1. An apparatus for producing timber mats including plural layers of timbers that are parallel to each other and offset from each another at uniform intervals in each layer, wherein timbers in adjacent layers are oriented perpendicular to one another forming an array of intersections spaced in longitudinal columns and lateral rows, the apparatus comprising:
a timber mat layup table;
a first lateral timber input oriented in a first direction and arranged at a first side of the timber mat layup table;
a second lateral timber input oriented in a second direction opposite, coaxial and parallel to the first direction and arranged at a second side of the timber mat layup table opposite to the first side of the timber mat layup table;
a longitudinal timber input oriented in a third direction perpendicular to the first direction and the second direction and arranged at a third side of the timber mat layup table;
a timber mat output oriented in the third direction arranged at a fourth side of the timber mat layup table opposite to the third side of the timber mat layup table;
a timber mat drilling table arranged adjacent to the timber mat output on a side of the timber mat output that is opposite to the timber mat layup table;
a gang drill arrangement that is movable in the first direction and in the second direction and includes plural drilling heads spaced in the third direction to drill the timber mat including plural layers of mutually perpendicular timbers in a vertical direction at the intersections of the timbers.

2. The apparatus for producing timber mats according to claim 1, further comprising
a pick and place arm positioning individual timbers from the first lateral timber input on the timber mat layup table;
a pick and place arm positioning individual timbers from the second lateral timber on the timber mat layup table; and
a pick and place arm positioning individual timbers from the longitudinal timber input on the timber mat layup table.

3. The apparatus for producing timber mats according to claim 1, further comprising individual timber positioning devices at each timber input to position timbers along their extensions for mat keying.

4. The apparatus for producing timber mats according to claim 2, further comprising individual timber indexing and reversal devices at each timber input to provide individual timbers to the respective pick and place arms.

5. The apparatus for producing timber mats according to claim 1, further comprising circular saws at each timber input to cut timbers to length at both ends.

6. The apparatus for producing timber mats according to claim 5, further comprising centering devices at each timber input centering timbers for the circular saws.

7. The apparatus for producing timber mats according to claim 6, further comprising finger hooks at each timber input providing individual timbers to the centering devices.

8. The apparatus for producing timber mats according to claim 1, further comprising timber column de-stackers at each timber input.

9. The apparatus for producing timber mats according to claim 1, further comprising a column separator at each timber input.

10. The apparatus for producing timber mats according to claim 1, further comprising a timber bundle infeed conveyor at each timber input.
Assembly table adjacent to drilling table

11. A method for producing timber mats, comprising the steps:
feeding timbers in at least one lateral direction to a timber mat layup table through at least one lateral timber input;
feeding timbers in a longitudinal direction perpendicular to the at least one lateral direction to the timber mat layup table through a longitudinal timber input;
laying up timbers in at least two layers with the timbers of each layer arranged perpendicular to one another to form a timber mat;
moving the timber mat from the timber mat layup table through a timber mat output coaxial and parallel to the longitudinal timber a side of the timber mat layup table that is opposite to the longitudinal timber input to a drilling table arranged adjacent at the mat output opposite to the mat layup table;
drilling the timber mat through a gang drill a arrangement at the drilling table which gang drill arrangement is movable back and forth in the lateral direction and includes plural drilling heads spaced in the longitudinal direction to drill the timber mat at intersection points of the timbers.

12. The method for producing timber mats according to claim 11, further comprising operating pick and place arms for timbers in at least 2 directions, wherein the pick and place arms place timbers on the timber mat layup table.

13. The method for producing timber mats according to claim 11, further comprising operating lateral movement devices to offset timbers in one layer longitudinally relative to each other for mat keying.

14. The method for producing timber mats according to claim 13, further comprising operating individual timber indexing and reversal devices at each timber input to provide individual timbers to respective pick and place arms.

15. The method for producing timber mats according to claim 11, further comprising operating at least one circular saw arrangement cutting timbers to length at both ends.

16. The method for producing timber mats according to claim 15, further comprising operating centering devices to center timbers for the circular saw arrangement.

17. The method for producing timber mats according to claim 16, further comprising operating a finger grabber to provide timbers to a centering device.

18. The method for producing timber mats according to claim 11, further comprising operating a column de-stacker

19. The method for producing timber mats according to claim 11, further comprising operating a column separator

20. The method for producing timber mats according to claim 11, further comprising operating a timber bundle infeed conveyor.
